(19) United States
(12) Patent Application Publication
(10) Pub. No.: US 2022/0060591 A1
(43) Pub. Date: Feb. 24, 2022

(54) AUTOMATED DIAGNOSES OF ISSUES AT PRINTING DEVICES BASED ON VISUAL DATA

(71) Applicant: Hewlett-Packard Development Company, L.P., Spring, TX (US)

(72) Inventors: Qian Lin, Palo Alto, CA (US); M. Anthony Lewis, Palo Alto, CA (US)

(73) Assignee: Hewlett-Packard Development Company, L.P., Spring, TX (US)

(21) Appl. No.: 17/417,920

(22) PCT Filed: Jan. 10, 2019
(86) PCT No.: PCT/US2019/013078

§ 371 Date: Jun. 24, 2021

(51) Int. Cl. H04N 1/00; G06T 7/00; G06N 3/08

(52) U.S. Cl. CPC H04N 1/00061; G06T 7/0002; H04N 1/00029; H04N 1/00005; G06N 3/08

(57) ABSTRACT

An example of an apparatus is provided. The apparatus includes an input device to receive camera data. The camera data is associated with a printing device. The apparatus further includes an analysis engine to analyze the camera data with a convolutional neural network model to identify an issue. The apparatus also includes a resolution engine to determine a solution for the issue.

### BACKGROUND

A printing device may generate prints during operation. In some cases, the printing device may develop issues such as introducing defects into the printed document which are not present in the input image. The defects may include streaks or bands that appear on the print. The defects may be an indication of a hardware failure or a direct result of the hardware failure. In some cases, the defects may be identified with a side by side comparison of the intended image (i.e. a reference print) with the print generated from the image file.

### BRIEF DESCRIPTION OF THE DRAWINGS

Reference will now be made, by way of example only, to the accompanying drawings in which:

FIG. 1 is a block diagram of an example apparatus to resolve issues in a printing device based on visual information;

FIG. 2 is a block diagram of another example apparatus to resolve issues in a printing device based on visual information;

FIG. 3 is a block diagram of another example apparatus to resolve issues in a printing device based on visual information;

FIG. 4a is a front view of an example of a smartphone implementation of the apparatus of FIG. 3;

FIG. 4b is a back view of an example of a smartphone implementation of the apparatus of FIG. 3; and

FIG. 5 is a flowchart of an example method of resolving issues in a printing device based on visual information.

### DETAILED DESCRIPTION

Although there may be a trend to paperless technology in applications where printed media has been the standard, such as electronically stored documents in a business, printed documents are still widely accepted and may often be more convenient to use. In particular, printed documents are easy to distribute, store, and be used as a medium for disseminating information. Accordingly, printing devices continue to be popular for generating printed documents.

With repeated use of any printing device over time, the printing device may encounter an error to be rectified with user intervention. For example, printing devices may include various parts or components that may wear down over time and eventually fail, especially moving parts or parts that may experience substantial temperature changes leading to warping. In addition, overall performance of the printing device may also degrade over time as moving parts may wear down. The overall performance degradation of the device may be a combination of software performance degradation and hardware performance degradation or failure. Upon a printing device failure, various indicators may be used to indicate the cause of the failure to a user or administrator so that the user or administrator may implement a solution.

In some examples, the printing device may not provide any indication of a cause of a failure or even indicate a failure whatsoever. Accordingly, a determination of poor performance is to be made based on the observed behavior or output generated by the printing device. It is to be appreciated that in some examples, the specific cause of the performance degradation or failure may be not be readily identifiable. Therefore, troubleshooting the issue may involve significant amounts of time from a technical support representative.

To reduce the number of calls to and/or to increase the efficiency of addressing issues involving a technical support center, a diagnostic device may be used to diagnose and provide instructions to implement a solution to an issue on a printing device. Therefore, the diagnostic device may provide a library of issues and solutions where a user or administrator may be able to carry out a troubleshooting process or repair the issue. For example, the solutions may include directions for a user or administrator to follow and thus resolve the issue without involving a call center or technician visit.

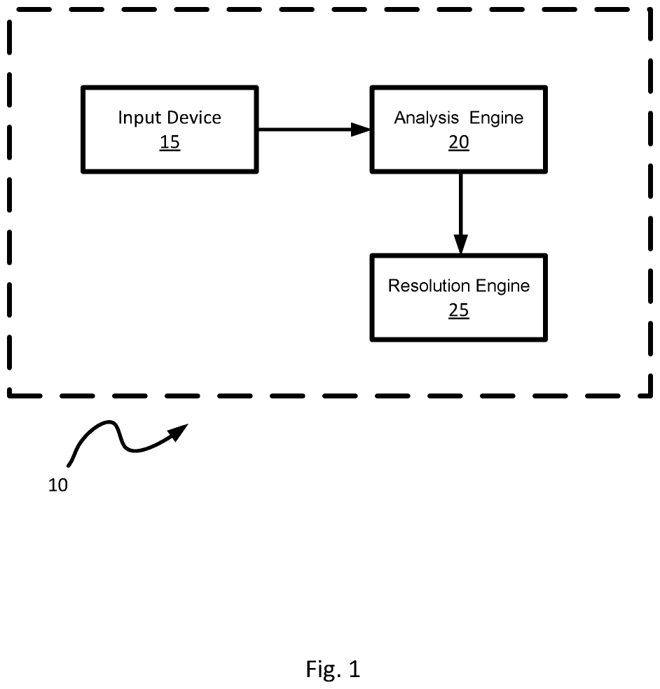

Referring to FIG. 1, an example of an apparatus to resolve issues in a printing device based on visual information is generally shown at 10. The apparatus 10 may include additional components, such as various memory storage units, interfaces to communicate with other devices, and further input and output devices to interact with a user or an administrator of the apparatus 10. In addition, input and output peripherals may be used to train or configure the apparatus 10 as described in greater detail below. In the present example, the apparatus 10 includes an input device 15, an analysis engine 20, and a resolution engine 25. In the present example, each of the analysis engine 20 and the resolution engine 25 may be separate components such as separate microprocessors in communication with each other within the same computing device. In other examples, the analysis engine 20 and the resolution engine 25 may be separate self-contained computing devices communicating with each other over a network. Although the present example shows the analysis engine 20 and the resolution engine 25 as separate physical components, in other examples, the analysis engine 20, and the resolution engine 25 may be part of the same physical component such as a microprocessor configured to carry out multiple functions. In such an example, each engine may be used to define a piece of software used to carry out a specific function.

In the present example, the input device 15 is to receive camera data associate with a printing device. Camera data is not particularly limited and may be any data that provides an indication of an issue of the printing device. In the present example, the camera data is visual data such as a standard image. The manner by which the input device 15 receives the camera data is not particularly limited. For example, the input device 15 may be a bus connecting a processor to another component such as a communication interface, such as a network interface card to receive camera data from an external device over a network. The external device from which the camera data originates is not limited and may be a client device, such as a smartphone or personal computer. The external device may also be a camera connected to the apparatus 10 via a direct connection, or connected to a client device in communication with the apparatus 10 via a network, such as the Internet or a local office network. In other examples, the input device 15 may be a sensor or other measuring device, such as a camera, to capture camera data directly. In such an example, the apparatus may be relatively portable such that the input device 15 may be aligned with the printing device to capture the camera data.

The camera data is not particularly limited. In the present example, the camera data may include an image of the printing device to identify the printing device. In particular, a specific representation of the printing device may be requested. The representation requested may include an identifier of the printing device such as a model number, serial number, barcode, or a Quick Response (QR) code. In some examples, an image of the printing device may be sufficient to identify the printing device using image recognition techniques such as the application of a convolutional neural network model, or other model capable of image recognition.

The camera data may also include information that may be indicative of an issue with the printing device. The issue is not particularly limited and may include a failure of the printing device to be fixed by a user or an administrator, such as an empty paper tray, empty toner cartridge, or a paper jam. In other examples, the issue may include a decrease in performance of the printing device, such as a decrease in print quality or printing speed. In some instances, the issue may generate an error message on the printing device to be included in the camera data. The error message is not limited and may be in the form of a text message that may or may not include an error code. The error message may also be in a machine-readable format such as a barcode or a QR code. In other examples, the error message may substitute with an indicator of an issue with the printing, such as a light or a LED to provide a warning or error indication. Further examples of indicators may include a mechanical indicator, such as flag indicating the amount of paper in a paper tray via a physical mechanism.

In examples without error messages or an indicator of an issue, the camera data may include output from the printing device. For example, if a user suspects that the performance and output quality of the printing device has degraded, the camera data may include an image of the printing device output. The image of the output from the printing device may include artifacts to provide an indication of an issue with the printing device. Examples of artifacts that may be present in the output from a printing device may include banding, ghosting, streaking, shotgun, spots, or other visible image defects. It is to be appreciated that artifacts may indicate a mechanical issue with a component of the printing device. For example, the printing device may have a clogged nozzle in an ink cartridge that is not detected by any sensor, such as if a piece of debris were to be lodged in the nozzle. This may result in the output from the printing device to have a missing color component. In another example, a sensor may fail in the system, such as an ink level sensor failing to detect that a reservoir is out of ink, may lead to a similar situation.

It is to be appreciated that the camera data may include multiple images. Each image included in the camera data may have different information. For example, a first image may include the model number of the printing device, a second image may include a display on the printing device displaying an error code, and a third image may be of the output from the printing device. Furthermore, the images forming the camera data may not be obtained from the same device. For example, different cameras and/or scanners may be used. Continuing with the able example of three images, the first image of the printing device may be captured using a portable electronic device, such as a smartphone with a camera, the second image may be a barcode scanned with a barcode scanner, and the third image may be obtained with a conventional scanner.

The analysis engine 20 is to analyze the camera data using a convolutional neural network model to identify an issue with the printing device. The manner by which the convolutional neural network model is applied is not limited. In the present example, the convolutional neural network is used to interpret an error message or an error indicator to identify the issue. As mentioned above, the camera data may include multiple images. Accordingly, the analysis engine 20 may identify the printing device to determine the type of the printing device. The manner by which the analysis engine 20 determines the type of the printing device, such as a model or manufacturer, is not particularly limited. In the present example, an image in the camera data may include information such as an identifier visible on the printing device that may be recognized using an image recognition procedure, such as applying a convolutional neural network model. In other examples, the printing device may send information to the apparatus 10 via a communication link such as a Bluetooth link, wireless network, or other type of link.

The manner by which the analysis engine 20 reads an error message generated by the printing device is not limited as various printing devices may have different methods for outputting an error message or error indicator. For example, the printing device may have a display to provide information to a user or administrator. It is to be appreciated that in some examples, the printing device may also use this display to generate error messages when the printing device encounters a failure, or warning messages when the printing device detects an imminent or potential failure. Accordingly, the analysis engine 20 may apply a convolutional neural network model to the images in the camera data to identify and interpret the error message. For example, the convolutional neural network model may first identify the display of the printing device. The application of the convolutional neural network may be enhanced with information about the type of the printing device in the camera data. Upon recognizing the display of the printing device, the analysis engine 20 may interpret the text of the error message. The text may then be used to identify the issue. It is to be appreciated that in some examples, the error message may include and error code which may be an alphanumeric code that is unique to a type of printing device, such as a model or manufacture of the printing device. In such examples, the identification of the issue may be dependent on the preliminary identification of the type of the printing device as error codes and messages may be unique.

As discussed above, in some examples, the camera data may not include an error message or error indicator. In such examples, the analysis engine 20 may analyze output from the printing device to determine an issue. For example, the analysis engine 20 may be used to analyze the output from the printing device using a convolutional neural network model to classify various potential issues. For example, the analysis engine 20 may be trained to classify the output as either normal or whether the ink level of a color may be low or empty such that the appearance of the output appears different. For example, if the black ink on a printing device is low, output generated by the printing device may appear faded. If another color is low, the image may appear distorted as if viewed through a color filter.

In some examples, the analysis engine 20 may not be able to identify an issue with the printing device based on the camera data. In such an example, the analysis engine 20 may generate an error message. In other examples, the analysis engine 20 may initiate an iterative process with the input device 15 to collect more data. For example, a user may be simply requested for more camera data to be collected. The additional data may then be processed with the same convolutional neural network model or a different convolutional neural network model or other machine learning model.

As another example, the analysis engine 20 may request specific camera data based on an analysis by the convolutional neural network of the initial camera data received by the input device. In this example, the initial camera data may be sufficient for the analysis engine 20 to identify a type of printing device, but to properly diagnose the issue, the specific model of the printing device needs to be known. Accordingly, the analysis engine 20 may request camera data of a specific identifying feature of the printing device, which may be at a hidden location or behind a cover.

The analysis engine 20 may also generate test images at the printing device for additional testing of print quality issues in an iterative process. For example, if the initial camera data suggests a print quality issue, such as a color imperfection, the analysis engine 20 may send a request to the printing device to generate test images at the printing device of pure colors with various gradations. The output generated at the printing device may then be captured with the input device 15 to be analyzed by the analysis engine 20 to identify the issue.

The resolution engine 25 is to determine a solution for the issue identified by the analysis engine 20. The manner by which the resolution engine 25 determines the solution is not particularly limited. In the present example, the resolution engine 25 may generate a request for a solution based on the issue and the type of printing device obtained from the identifier in the camera data. The request may then be transmitted to an external database having a library of solutions associated with the identified issue on the printing device. In other examples the resolution engine 25 may search an internal database for the solution. In another example, the resolution engine 25 may use a combination of different databases to obtain a solution for the issue.

As an example, it may be assumed that the printing device is an inkjet printing device and the analysis engine 20 has determined that the printing device is low on black ink, either through error code analysis or output analysis. In this example, the solution may be to replace an ink cartridge for the black ink. Since the type of printing device is also known, the resolution engine 25 may search for possible solutions for the specific type of printing device. In particular, the resolution engine 25 may obtain a solution that includes instruction on how to replace an ink cartridge based on the type of printing device. Other printing devices that use a toner cartridge or ink reservoir may include instructions on how to change a toner cartridge or refill the reservoir. The solution may then be presented to the user or administrator for further implementation. It is to be appreciated that in other examples, other types of printing devices may be analyzed by the analysis engine 20, such as laser jet printing devices, thermal printing devices, three-dimensional printing devices, etc.

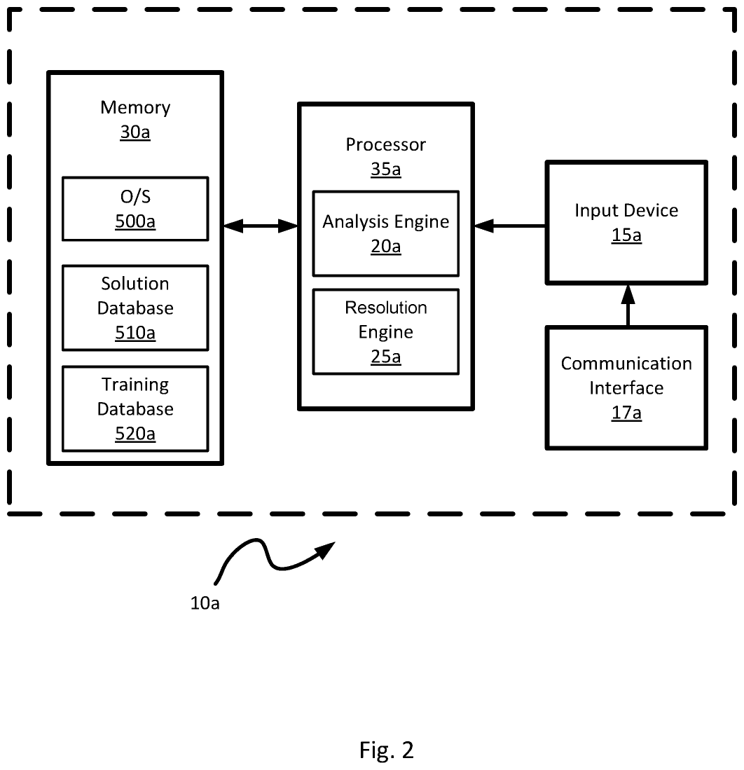

Referring to FIG. 2, another example of an apparatus to resolve issues in a printing device based on visual information is shown at 10a. Like components of the apparatus 10a bear like reference to their counterparts in the apparatus 10, except followed by the suffix “a”. The apparatus 10a includes an input device 15a, a communication interface 17a, a memory storage unit 30a, and a processor 35a. In the present example, an analysis engine 20a and a resolution engine 25a are implemented by the processor 35a.

The communications interface 17a is to communicate with external devices, such as client devices over a network and to pass data from the external device to the input device 15a. Accordingly, the communications interface 17a may be to receive camera data from multiple client devices. The manner by which the communications interface 17a receives the camera data is not particularly limited. In the present example, the apparatus 10a may be a cloud server located at a distant location from the client devices which may each be broadly distributed over a large geographic area. Accordingly, the communications interface 17a may be a network interface communicating over the Internet. In other examples, the communication interface 17a may connect to the external client devices via a peer to peer connection, such as over a wire or private network. It is to be appreciated that in this example, the apparatus 10a may carry out diagnoses of printing devices as a service. In other examples, the apparatus 10a may be part of a printing device management system capable of assessing printing devices for issues at several locations.

The memory storage unit 30a is connected to the input device 15a, in this example via the processor 35a, to store the camera data received via the communication interface 17a as well as processed data. In addition, the memory storage unit 30a is to maintain a solution database 510a and a training database 520a.

In the present example, the solution database 510a is to store a set of known issues along with the associated solution in a searchable format. For example, the solution database 510a may be used to match an error message with a solution. Accordingly, the solution database 510a may have an entry for each error message for known printing devices. The solution stored in the solution database 510a may provide instructions to a user or administrator of the printing device to resolve the issue. The solutions stored in the solution database 510a are not particularly limited. For example, the solutions may include audio, images and video. Images, videos, and graphics may be anchored to feature points on the device image, allowing an augmented reality output to guide a user or administrator through a process to resolve the issue as discussed in greater detail below.

In the present example, the memory storage unit 30a may also maintain a table in the training database 520a to store and index the training dataset. For example, the training dataset may include samples of test images having various error codes or indications. In other examples, the training database 520a may include test images with synthetic artifacts injected into the test images to train a convolutional neural network to recognize issues from the output of the printing devices. In the present example, the convolutional neural network is not limited and may be any available convolutional neural network. For example, the convolutional neural network may be operated by a third part on an external server to conserve resources of the apparatus 10a. It is to be appreciated that once the model has been trained, it may be used by the analysis engine 20a.

Furthermore, by maintaining training data in the training database 520a, it is to be appreciated that additional test images may be generated from camera data through regular use. The additional test images may be added to the training database 520a for continued retraining of the convolutional neural network over time. In addition, storing the training data in the training database 520a allows for the apparatus 10a to change the model used by the analysis engine 20a to another convolutional neural network, another type of neural network, or another type of machine learning model.

As an example, for training purposes, a training database 520a may be used to collect potential training data for further refinement of the convolutional neural network. The test images are not limited and may be obtained from various sources. In the present example, the test images may be generated using simulated streaks that were printed to a document and re-scanned. In addition, the training database 520a may provide test images directed to the various error messages and error indications that may be provided in the camera data (i.e. observed from the printing devices).

The memory storage unit 30a components is not particularly limited. For example, the memory storage unit 30a may include a non-transitory machine-readable storage medium that may be, for example, an electronic, magnetic, optical, or other physical storage device. In addition, the memory storage unit 30a may store an operating system 500a that is executable by the processor 35a to provide general functionality to the apparatus 10a. For example, the operating system may provide functionality to additional applications. Examples of operating systems include Windows™, macOS™, iOS™, Android™, Linux™, and Unix™. The memory storage unit 30a may additionally store instructions to operate at the driver level as well as other hardware drivers to communicate with other components and peripheral devices of the apparatus 10a.

The processor 35a may include a central processing unit (CPU), a graphics processing unit (GPU), a microcontroller, a microprocessor, a processing core, a field-programmable gate array (FPGA), an application-specific integrated circuit (ASIC), or similar. In the present example, the processor 35a and the memory storage unit 30a may cooperate to execute various instructions. The processor 35a may execute instructions stored on the memory storage unit 30a to carry out processes such as to assess the print quality of a received scanned image of the printed document. In other examples, the processor 35a may execute instructions stored on the memory storage unit 30a to implement the analysis engine 20a and the resolution engine 25a. In other examples, the analysis engine 20a and the resolution engine 25a may each be executed on a separate processor (not shown). In further examples, the analysis engine 20a and the resolution engine 25a may each be executed on separate machines, such as from a software as a service provider or in a virtual cloud server.

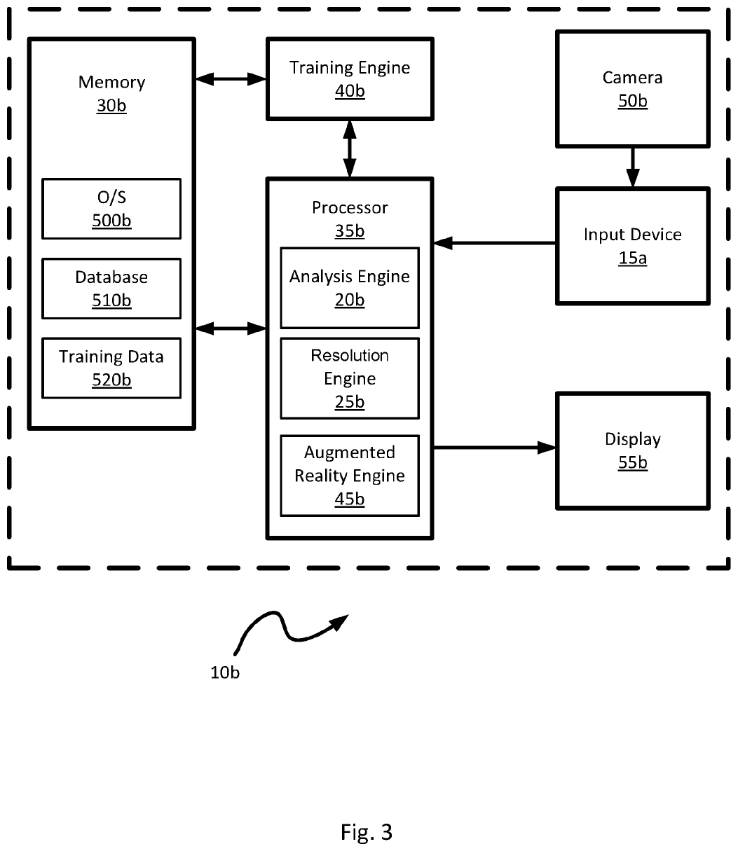

Referring to FIG. 3, another example of an apparatus to resolve issues in a printing device based on visual information is shown at 10b. Like components of the apparatus 10b bear like reference to their counterparts in the apparatus 10 and the apparatus 10a, except followed by the suffix “b”. The apparatus 10b includes an input device 15b, a memory storage unit 30b, a processor 35b, a training engine 40b, a camera 50b, and a display 55b. In the present example, an analysis engine 20b, a resolution engine 25b, and the augmented reality engine are implemented by the processor 35b.

The training engine 40b is to train a model used by the analysis engine 20b. The manner by which the training engine 40b trains the convolutional neural network model used by the analysis engine 20b is not limited. In the present example, the training engine 40b may use images stored in the training database 520b to train the convolutional neural network model. For example, the training database 520b may include images of multiple printing devices, error messages, error indicators, and output from printing devices. The images may be from different perspectives with varying dimensions and aspect ratios and captured using a plurality of image capture devices, such as cameras, smartphones, and scanners. From the images store in the training database 52ab, a subset of the images may be selected and used to validate the training after an epoch of the training process. For the images of output from the printing devices, common data augmentation techniques may be applied to the training images to increase their variability and increase the robustness of the neural network to different types of issues arising from print defects as well as variations that may appear in the camera data. For example, adding different levels of blur may help the network handle lower resolution images in the camera data. Another example is adding different amounts and types of statistical noise, which may help the network handle noisy input sources. In addition, horizontal flipping may substantially double the number of training examples. It is to be appreciated that various combinations of these techniques may be applied, resulting in a training set many times larger than the original number of images.

The camera 50b is in communication with the input device 15b and to generally capture images. In the present example, the camera 50b may be used to capture camera data for the input device 15b. In particular, the camera 50b is to capture camera data, which may include an image or a group of images, for the analysis engine 20b to analyze. The manner by which the image is captured using the camera 50b is not limited. For example, the camera 50b may be a stand-alone camera or a part of a tablet device or a smartphone device where the user may capture images when a printing device fails or shows poor performance. In some examples, the camera 50b may be operated by an application requesting specific images, such as an image with a model number, an image of an error message or indicator, or an image of output from the printing device.

Furthermore, the camera 50b may capture background data. The background data may include any image captured by the camera 50b. For example, the background data may be an image of a space, such as a room, in which the apparatus 10b is situated, which may include the printing device that is the subject of the camera data. The manner by which the camera 50b captures the background data is not particularly limited. For example, the camera 50b may continuously capture images and act as a viewfinder where the image at any given time may be considered to be background data.

In the present example, the camera 50b is to operate in a range of conditions that range from capturing image data at close range such as a printed document as output from the printing device or an error message displayed on the printing device to medium range, such as a perspective view of the printing device. For example, when the camera 50b may include appropriate sensor and optical components to measure image data over a wide variety of lighting conditions. In some examples, the apparatus 10b may be equipped with multiple cameras where each camera 50b may be designed for slightly different operating conditions to cover a wider range of lighting conditions.

In the present example, the augmented reality engine 45b is to render an output augmented reality image having augmented reality features. The output image may be based on the solution and the background data to provide detailed illustrations to complement text instructions or in the place of text instructions. The manner by which the output image is rendered is not particularly limited. For example, the output image may include a feature superimposed over a background image captured by the camera 50b. The feature is not particularly limited in the present example and may be a feature such as an arrow, circle or other markup. In other examples, the feature may be a highlight or adjustment in the brightness of a region in the background data.

The manner by which the feature is superimposed on the background is not particularly limited. For example, the augmented reality engine 45b may simply superimpose the feature over the background image at a specified location on the image. In other examples, the augmented reality engine 45b may analyze the background image and modify to the feature such that the feature is to be more seamlessly interwoven into the background image. In addition, the augmented reality engine 45b may identify areas in the background image where the feature may be superimposed so that the feature may be readily recognized instead of blending into a background. For example, the augmented reality engine 45b may identify blank spaces such as a wall of a room when the background image is taken in a room. In other examples, the augmented reality engine 45b may identify a printing device and remove everything else from the background data leaving a white background.

It is to be appreciated that the augmented reality engine 45b may also add various features or effects to enhance the aesthetic appearance of the output image. It is to be appreciated that this may allow a user to view the printing device from multiple angles through a personal electronic device, such as a smartphone. For example, if the issue is identified to be a paper jam, the augmented reality engine 45b may generate an arrow to indicate a panel on the printing device to be opened for inspection. As a user moves around the printing device with the personal electronic device, the background image may be updated and the arrow feature will be updated on the display 5b. Furthermore, if the user moves closer to the printing device (or zooms in), the arrow will be updated. It is to be appreciated that this allows for a user to readily identify the component for service if there are many complicated serviceable components in close proximity on the printing device.

The display 55b is to output a solution to an issue of the printing device. In the present example, the solution may be a set of instructions displayed for a user or administrator to view and follow to resolve the issue with the printing device. For example, the resolution engine 25b may generate a set of instructions with images outlining steps. In addition, an augmented image may be generated to further illustrate the solution to the issue. For example, an image of the printing device may be displayed with highlighted features to illustrate the components to be serviced. In the present example, the augmented image may be the image generated by the augmented reality engine 45b.

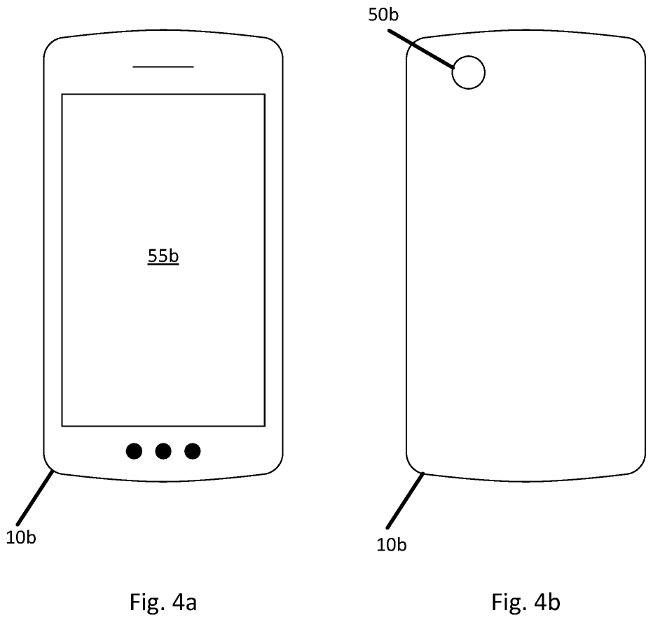

Accordingly, it is to be appreciated that the apparatus 10b provides a single device, such as a smartphone, to resolve issues in a printing device based on visual information as shown in FIG. 4a and FIG. 4b. In particular, since the apparatus 10b includes a camera 50b and a display 55b, it may allow for rapid local assessments of print quality.

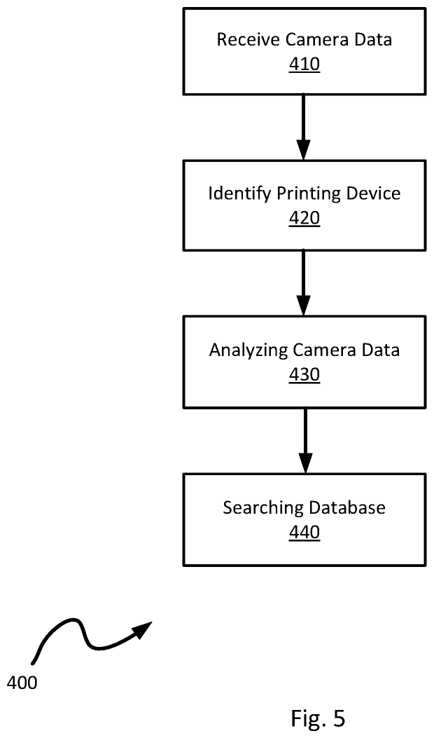

Referring to FIG. 5, a flowchart of an example method of resolving issues in a printing device based on visual information is generally shown at 400. In order to assist in the explanation of method 400, it will be assumed that method 400 may be performed with the apparatus 10. Indeed, the method 400 may be one way in which the apparatus 10 may be configured. Furthermore, the following discussion of method 400 may lead to a further understanding of the apparatus 10. In addition, it is to be emphasized, that method 400 may not be performed in the exact sequence as shown, and various blocks may be performed in parallel rather than in sequence, or in a different sequence altogether.

Beginning at block 410, camera data associated with a printing device is to be received. The manner by which the camera data is received is not particularly limited. For example, the camera data maybe captured by an external device, such as a client device having a camera, at a separate location. It is to be appreciated that the client device is not limited and may include various devices such as smartphones or tablets designed to diagnose printing devices. In some examples, the client device may be the same as the printing device, such as in the case of an all-in-one printer where the output may be re-scanned using the scanner to detect print quality issues. The camera data may then be transmitted from the external device, such as a camera, a smartphone, a tablet, or a scanner, to the apparatus 10 for additional processing.

Block 420 involves identifying the printing device associated with the camera data. In the present example, the camera data may include an image of the printing device to identify the printing device. In particular, a specific representation of the printing device that includes an identifier of the printing device such as a model number, serial number, barcode, or a Quick Response (QR) code may be provided. In some examples, an image of the printing device may be sufficient to extract the identifier from the image and subsequently identify the printing device using image recognition techniques such as the application of a convolutional neural network model, or other model capable of image recognition. In other examples, the printing device may electronically send information, such as an identifier, via a communication link such as a Bluetooth link, wireless network, or other type of link to the device capturing the camera data. The information may then be passed on to the apparatus along with the camera data.

Block 430 involves analyzing the camera data received at block 410 with a convolutional neural network model to identify an issue with the printing device. The manner by which the convolutional neural network model is applied is not limited. In the present example, the convolutional neural network is used to interpret an error message or an error indicator to identify the issue. The application of the convolutional neural network may also be carried out at a separate server maintained and operated by a service provider. In other examples, the convolutional neural network may be part of the apparatus 10.

Block 440 searches a database of solutions to determine a solution for the issue identified in block 430. The manner by which the solution is determined is not particularly limited. In the present example, a resolution engine 25 may request a solution from an external database based on the identified issue. In other examples, solutions may be stored internally and an internal database may be searched for the solution. In another example, a combination external and internal resources may be used.

Furthermore, it is to be appreciated that issues for different printing devices, such as different models and/or different manufacturers may have different solutions. Accordingly, the identifier of the printing device obtained from the execution of block 420 may be part of the query to obtain the solution.

Once the solution is obtained by the apparatus 10, it is to be provided to a user or administrator for additional follow-up. For example, if the camera data is received from an external device, such as client device, the solution may be transmitted back to the external device in the form of a message with instructions. In other examples, such as with the apparatus 10b where the apparatus 10b is a self-sufficient diagnosis apparatus, the solution may be displayed on a display screen for the user to review. The manner by which the solution is displayed is not limited and may include text instructions, augmented illustrations, or an augmented reality experience to guide a user to resolving the issue.

Various advantages will now become apparent to a person of skill in the art. For example, the apparatus may provide for addressing and resolving issues in a printing device based on visual information. Furthermore, the method may also identify issues with print quality at an earlier stage. In particular, this increases the accuracy of the diagnosis and reduces the amount of time for engaging support staff to deal with issues associated with a printing device.

It should be recognized that features and aspects of the various examples provided above may be combined into further examples that also fall within the scope of the present disclosure.

What is claimed is:

1. An apparatus comprising:
an input device to receive camera data, wherein the camera data is associated with a printing device;
an analysis engine to analyze the camera data with a convolutional neural network model to identify an issue; and
a resolution engine to determine a solution for the issue.

2. The apparatus of claim 1, further comprising a communication interface in communication with the input device, wherein the communication interface is to receive the camera data from a client device.

3. The apparatus of claim 1, further comprising a memory storage unit connected to the input device, the memory storage unit to store the camera data.

4. The apparatus of claim 1, wherein the camera data includes information to identify the printing device.

5. The apparatus of claim 4, wherein the analysis engine is to identify the issue dependent on a type of the printing device identified by the information.

6. The apparatus of claim 1, further comprising a camera in communication with the input device, wherein the camera is to capture background data.

7. The apparatus of claim 6, further comprising a display to output the solution for a user.

8. The apparatus of claim 7, further comprising an augmented reality engine to render an output image based on the solution and the background data, wherein the augmented reality engine is to superimpose a feature on the background data.

9. A method comprising:
receiving camera data, wherein the camera data is associated with a printing device;
identifying the printing device with the camera data based on an identifier;
analyzing the camera data with a convolutional neural network model to identify an issue; and
searching a database to determine a solution for the issue, wherein the solution is based on the identifier of the printing device.

10. The method of claim 9, wherein receiving the camera data comprises receiving the camera data from a client device, wherein the client device includes a camera to capture the camera data.

11. The method of claim 9, further comprising displaying the solution on a display fora user.

12. The method of claim 11, wherein displaying the solution comprises generating an augmented reality image to guide the user.

13. A non-transitory machine-readable storage medium encoded with instructions executable by a processor, the non-transitory machine-readable storage medium comprising:
instructions to receive camera data, wherein the camera data is associated with a printing device;
instructions to extract an identifier of the printing device from the camera data;
instructions to analyze the camera data with a convolutional neural network model to identify an issue caused by the printing device;
instructions to generate a request for a solution based on the issue and the identifier; and
instructions to transmit the request to an external library for the solution.

14. The non-transitory machine-readable storage medium of claim 13, further comprising instructions to capture background data from a camera continuously, wherein the background data is displayed on a display.

15. The non-transitory machine-readable storage medium of claim 14, further comprising instructions to generate an augmented reality image based on the solution and the background data, wherein the augmented reality image is to include features superimposed on the background data.
